(19) United States
(12) Patent Application Publication
(10) Pub. No.: US 2002/0035480 A1
(43) Pub. Date: Mar. 21, 2002

(54) Alternative dispute resolution preparation method and systems

(76) Inventors: Robert Gordon, Dallas, TX (US); Maurine Skeeters, Dallas, TX (US); Leon Ashley Peek, Denton, TX (US); Daniel Brookshier, Plano, TX (US)

Correspondence Address: James J. Murphy, 1201 Elm, 54th Fl., Dallas, TX, 75270, US

(21) Appl. No.: 09/895,675

(22) Filed: Jun. 28, 2001

Related U.S. Application Data
(60) Provisional application No. 60/214,839, filed on Jun. 28, 2000.

(51) Int. Cl. G06F 17/60

(52) U.S. Cl. 705/1; 345/758

(57) ABSTRACT

A method of performing a selected alternate dispute procedure online comprises the steps of selecting at least one alternate dispute resolution professional and setting up a main chat room accessible by the alternate dispute resolution professional and first and second disputing parties. A private chat room is set up which is accessible by a selected one of the disputing parties and counsel for the selected disputing parties for conducting private information exchanges. A virtual presenter is accessible and the main chat room is activated for presenting evidence. The alternate dispute resolution procedure is then conducted through the exchange of information through chat in the main chat room and the presentation of evidence using the virtual presenter.

### CROSS-REFERENCE TO RELATED APPLICATIONS

This application is related to the provisional application for patent entitled “ALTERNATIVE DISPUTE RESOLUTION PREPARATION METHODS AND SYSTEMS filed Jun. 28, 2000 by the inventors Gordon, Skeeters, Peek, and Brookshier and granted U.S. Ser. No. 60/214,839, currently pending.

### BACKGROUND OF THE INVENTION

1. Field of the Invention

The present invention relates in general to the field of dispute resolution conducted over a data processing network and in particular to using the Internet to apply a multi-discipline methodology and system to prepare parties for the resolution of legal disputes through mediation, arbitration and summary jury trials. For the first time, preparatory services for dispute resolution methods are applied to a computer network to produce a method of helping parties resolve disputes in cost affective manner which is free from traditional and logistical constraints. Lack of thoughtful preparation is the reason using alternative dispute resolution (ADR) lead to disappointing results for the parties.

2. Description of the Related Art

In the normal course of doing business, control and money disputes are often inevitable. Parties sometimes disagree as to their individual obligations regardless as to how well a contract is negotiated and written. Disputes can lead to delayed shipments of valuable items, claims of nonperformance, loss of monies, and similar misunderstandings. Solving disputes between adverse parties usually falls within the province of the legal system. Many times disputes can only be resolved by the filing of a lawsuit or initiating some dispute resolution mechanism. When this occurs, one party alleging certain causes of action against the other party files the lawsuit or demand against the other party. This can concern diverse matters such as intellectual property or marital property.

Many lawsuits result from misunderstandings about written or oral contracts between two or more parties. Often these contracts contain dispute resolution provisions which contractually bind the parties to non-traditional dispute resolution forums such as arbitration, mediation or summary jury trials. Even in situations where a lawsuit has been filed, many parties recognize the benefits of attempting to resolve a lawsuit before trial in a non-adversarial method. Often a judge or magistrate will order mediation. Thus, alternative dispute resolution (“ADR”) techniques such as mediation, arbitration or summary jury trials are often used to settle disputes before the parties go through the expense of a courtroom trial.

Mediation is an ADR technique that is less formal than traditional litigation. Unlike a jury, judge, or arbitrator, a mediator usually does not have the power to render a binding decision. A mediator does not hold evidentiary hearings as would an arbitrator or judge. In mediation, both parties are usually given an opportunity prepare position papers. In complex cases, these position papers may include key documents and exhibits, and can take the form of a notebook. The position papers are given to the mediator before the mediation begins. If the parties and mediator agree, the papers are also presented to the other side (usually at the beginning of mediation).

The mediation usually begins with a joint conference of all parties and the mediator. The plaintiff presents a summary of its case to the mediator and the other parties in the dispute. This summary presentation may include a discussion of the plaintiff's understanding of the issues, the facts surrounding the dispute, what he/she wants, and why. This presentation can also include key documents and exhibits. The defendant(s) then responds and makes similar presentations to the mediator and the other parties. In this initial session, the mediator attempts to gather as many facts as possible and attempts to clarify discrepancies. The joint session allows the mediator to understand the perceptions of each party, their interests, and their positions on the issues, both factually and legally.

After the joint presentation, each party adjourns to individual breakout rooms or caucuses. The mediator then meets separately with the parties. The mediator may shuttle back and forth between parties and bring them back to joint sessions at appropriate intervals.

The mediator acts as a facilitator to keep settlement discussions focused and avoid new outbreaks of disagreement which can occur during face-to-face negotiations. The mediator attempts to reduce the controversy into a workable settlement solution. If the mediation session fails to reach a settlement of any or all of the issues, the parties may submit arbitration, a summary trial, or traditional litigation. Typically, the information offered in mediation may not be used in subsequent litigation. If the mediation is ordered by a judge or magistrate, the mediator will often submit a mediator's report to the judge or magistrate.

Although mediation sessions can be conducted much more quickly than traditional jury trials, they can be expensive to prepare for and require advanced planning due to the logistics of assembling attorneys, parties, exhibits and witnesses.

Some of the costs associated preparation for mediation sessions include the preparation and shipping of exhibits; witness transportation; lodging fees; hourly charges for attorneys' time and expenses, and the mediator's time and efforts. Preparation also includes the developing of strategies and explanations and rationales for arguments and evidence. Additionally, an appropriate facility must be reserved usually with enough space for all parties to meet and several caucus rooms. Preparation for any ADR procedure is usually conducted at a central location because the attorneys and the parties must be gathered together to see, hear and discuss the presentations. Because of these fixed costs, preparation is expensive—especially when the parties do not reside in the same city or state.

In the case of arbitration, preparation is also crucial to the Parties and their attorneys in being ready to resolve the dispute. In arbitration, the Parties have agreed that their dispute will be decided by one or more arbitrators whose judgment will typically be binding. This binding result has the same force and effect as a Court judgment or jury verdict. Since the stakes in business litigation can be very high as in cellular microchip design or marketing agreements for oil and gas products or for security transactions, the Parties have given tremendous discretion and trust to the arbitrators and the arbitration process. In this regard, preparation and strategy for the arbitration is not less vital than for a full jury trial or bench trial.

In the summary jury trial, the Parties to a business or personal injury lawsuit or dispute have agreed to present the issue to a specially selected group of jurors who will engage in a condensed proceeding. Great economies are achieved by taking a case and its evidence that typically will be conducted over a period of weeks or months and distilling it into a period of one day. Typically, a retired federal or state judge will be hired by the Parties to preside over the summary jury trial as an ADR expert. The summary jury trial and the resulting verdict are then observed by the parties. The alternative dispute resolution (ADR) expert then guides the parties and their lawyers through mediation. The parties and their legal counselors then work to resolve the dispute based upon the forecasted verdict of the summary jury.

Though the process is cost effective and time efficient through the suspension of much of the cumbersome aspects of trial, the preparation by each side for the proceeding is no less assiduous. There are strategies that must be prepared in terms of persuasive themes, credible evidence and ideal juror profiles.

Online business methods are now developing which allow for mediation, arbitration and summary jury trial to be conducted on line. Virtual Jury Methods and Systems, a provisional patent application filed Jan. 27, 2000, U.S. Ser. No. 60/178,435, is an example.

In preparatory ADR sessions, sometimes not all of the parties nor all of the attorneys and important witnesses can attend the session on the chosen date. Many times, a suitable location cannot be procured due to a shortage of locations in the forum where the case was to be tried. Coordination amongst the participants is vital and often the timing is preclusively restrictive because of the reduced dates when all participants could get together in one central location. These limitations often caused the parties to cancel or postpone mediation sessions.

Hence, there existed in the art a need to increase costs savings of conducting preparation for ADR procedures. This need encompasses the need to conduct preparation sessions in a cost effective manner, free from geographic constraints, and free from logistical constraints, while still providing fair and reasonable resolution of disputes. This need is clearly felt in the art, and is solved by the present invention.

### SUMMARY OF THE INVENTION

The present invention addresses the above-described needs. The present invention provides for a methodology to conduct preparations for ADR sessions utilizing the Internet as a communication medium between attorneys, consultants, client parties and witnesses. This methodology allows the mediation session to be conducted at various locations at the same time in a virtual courtroom or facility, providing a unified “location” where all participants congregate during the course of the mediation session. This invention allows the mediator to conduct preparation and rehearsal for a the mediation session from anywhere in the world. In a word, to conduct a mock mediation session. Additionally, this methodology allows the attorneys and the party-clients to view the mock session either real time or at a later time. Further, the present invention provides for a conference facility in which the attorneys and the Parties can critique, evaluate and improve the testimony, evidence, and arguments for their side.

The present invention provides for a methodology so that the preparation can be presented with on-line position papers. The attorneys can conduct breakout sessions with parties and consultants or conduct joint sessions for quick preparation for resolution of the dispute in a fair and concise manner.

The present invention presents various trial exhibits, graphics, counsel's arguments and the like using video streaming to allow the attorneys and the parties to view the material either real time or later.

In the case of jury trials, the field of trial consulting has evolved in order to apply behavioral science methodology to helping attorneys and their clients prepare for trial. This has taken the form of “mock trials” and “focus groups”, in part, to allow for the forecast of results of a trail. Mock bench trials which simulate a trial before a judge are also conducted by trial consultants in order to examine, study and rehearse their presentations. If the outcome of the jury trial or bench trial can be predicted with an acceptable margin of error, then settlement is always possible. In the case the resolution of all insurance claims including personal injury cases, this has proved valuable.

The present invention provides for mock arbitration, mock mediation and mock summary jury trials in order to help the parties understand their opportunities and exposures. Some ADR is now conducted online and this trend is expected to grow. The present invention allows for mock online ADR procedures as well.

Advantageously, the described procedures can be used to resolve disputes in instances where relatively small amounts of money are involved and/or the parties are widely dispersed. One particular case involves e-commerce where a customer and an online vendor are in dispute over cost, delivery, product quality, etc.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates, in block diagram form, a communication system in accordance with one embodiment of the present invention;

FIG. 2 illustrates, in block diagram form, a data processing system implemented in accordance with one embodiment of the present invention;

FIG. 3 is a flow chart describing an overview of the present invention;

FIG. 4 is a flow chart describing in detail one step of the present invention illustrated in FIG. 3, namely the methodology of readying the case for presentation;

FIG. 5 is a flow chart describing in detail one step of the present invention illustrated in FIG. 3, namely the methodology of reaching a settlement;

FIG. 6 is a block diagram illustrating the communications between chat rooms utilized in the present invention;

FIG. 7 is an example of a computer screen as seen by a participant involved in a private caucus;

FIG. 8 is an example of a computer screen as seen by a participant involved in a public assembly room;

FIG. 9 is an example of a computer screen as seen by a mediator involved in the mediation process;

FIG. 10 is an example of a computer screen showing a settlement offer;

FIG. 11 is a block diagram illustrating a preferred database system used for providing virtual ADR preparation services;

FIG. 12 shows a preferred profile search procedure;

FIG. 13 is a more detailed flow chart of a procedure for implementing the case profile search;

FIGS. 14A-D respectively, illustrate the procedures for a simulated virtual mediation, simulated virtual arbitration, virtual summary bench trial and simulated virtual summary jury trial, according to the principles of the present invention;

FIG. 15 is a flow chart of a preferred procedure 1500 for analyzing the session record generated during the procedure discussed above in connection with FIGS. 14A-D;

FIG. 16 is a flow chart of one particular method of performing content analysis on the information developed during either a mock or actual ADR procedure; and

FIG. 17 depicts one procedure for providing disbursements to the various participants.

### DESCRIPTION OF THE PREFERRED EMBODIMENTS

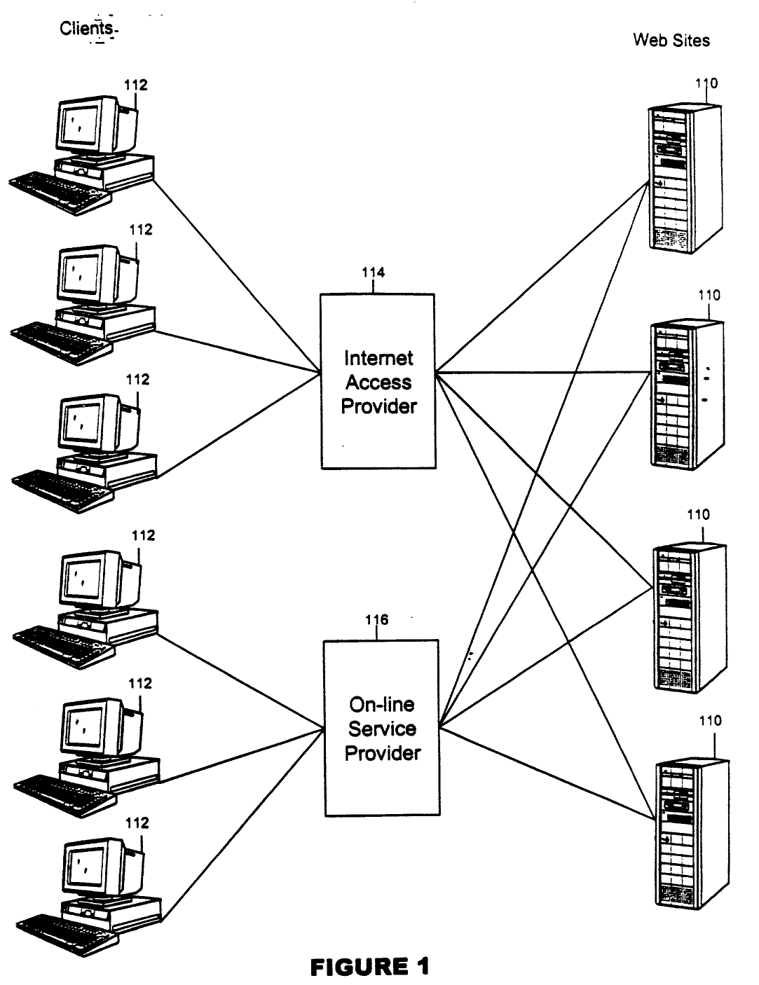

The principles of the present invention and their advantages are best understood by referring to the illustrated embodiment depicted in FIGS. 1-17 of the drawings, in which like numbers designate like parts. In the following description, well-known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art.

FIG. 1 illustrates a communication network based on a client-server model typically utilized in the Internet. The subsequent discussion and description of FIG. 1 are provided to illustrate the Internet environment utilized by the present invention.

Conceptually, the Internet comprises a large network of “servers” 110 that are accessible by “clients” 112. Each of the plurality of clients 112 is typically a user of a personal computer. Clients 112 access the Internet through some private Internet access provider 114 (such as Internet America™) or an on-line service provider 116 (such as America On-Line™, AT&T WorldNet™, and the like). Each of clients 112 may run on a “browser,” which is a known software tool used to access the servers (110) via the access providers (114 and 116). Each server 110 selectively operates a “web site” that supports files in the form of documents and pages. A network path to a server is identified by a uniform resource locator (URL) having a known syntax for defining a network connection.

As previously mentioned, the World Wide Web is a collection of servers on the Internet that utilizes Hyper Text Transfer Protocol (HTTP). HTTP is a known application protocol that provides users access to files using a standard page description language known as Hyper Text MarkUp Language (HTML). It should be noted that the files may be in different formats, such as text, graphics, images, sound, video, and the like. HTML provides basic document formatting and allows the developer to specify “links” to other servers or files. Use of an HTML-compliant browser involves specification of a link via the URL. Upon such specification, one of the clients 112 may make TCP/IP request to one of plurality of servers 110 identified in the link and receive a web page (specifically, a document formatted according to HTML) in return.

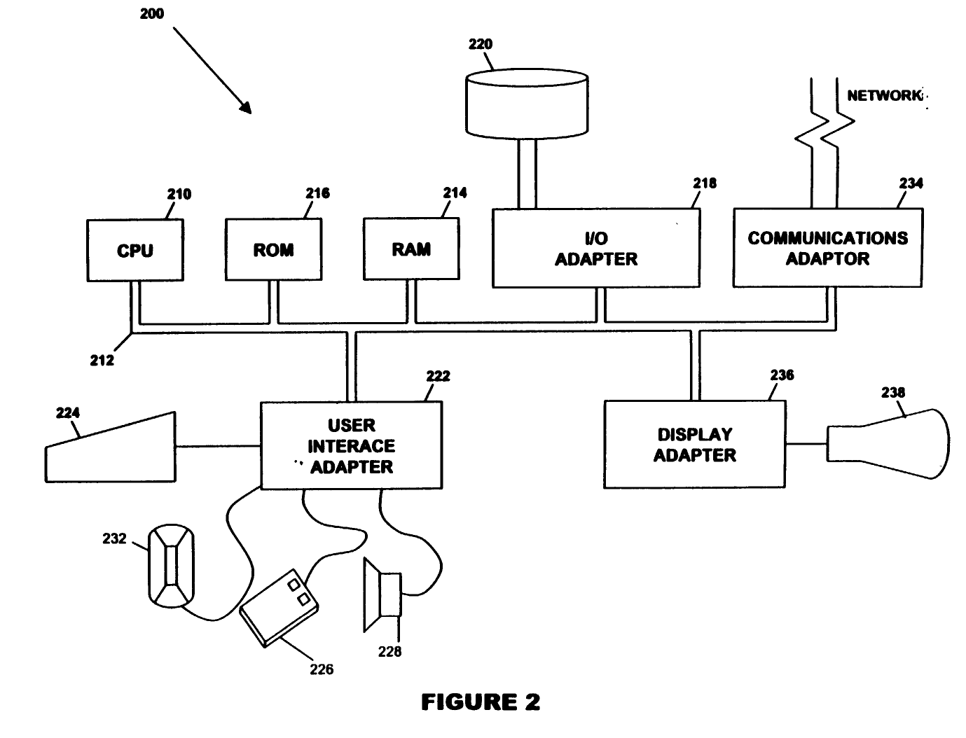

FIG. 2 illustrates a data processor 200 that may be utilized to implement a “client” (112) that executes the methodology of the present invention. Data processing system 200 comprises a central processing unit (CPU) 210, such as a microprocessor. CPU 210 is coupled to various other components via System bus 212. Read-only memory (ROM) 216 is coupled to the System bus 212 and includes a basic input/output system (BIOS) that controls certain basic functions of the data processing system 200. Random access memory (RAM) 214, I/O adapter 218, and communications adapter 234 are also coupled to System bus 212. I/O 218 may be a small computer system interface (SCSI) adapter that communicates with a disk storage device 220. Communications adapter 234 interconnects bus 212 with an outside network enabling the data processing system to communicate with other such systems. Input/output devices are also connected to System bus 212 via user interface adapter 222 and display adapter 236. Keyboard 224, trackball 232, mouse 226, and speaker 228 are all interconnected to bus 212 via user interface adapter 222. Display monitor 238 is coupled to system bus 212 by display adapter 236. In this manner, a user is capable of inputting to the system through keyboard 224, trackball 232, or mouse 226, and receiving output from the system via speaker 228 and display 238.

Some embodiments of the invention include implementations as a computer system program to execute the method or methods described herein, and as a computer program product. According to the computer system implementation, sets of instructions for executing the method or methods are resident in RAM 214 of one or more computer systems configured generally as described above. Until required by the computer system, the set of instructions may be stored as a computer program product in another computer memory. For example, in disk drive 220 (which may include a removable memory such as an optical disk or floppy disk for eventual use in disk drive 220).

Further, the computer program product can also be stored at another computer and transmitted in a computer readable medium when desired to the user's work station by a network or by an external network such as the Internet. One skilled in the art would appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

Note that the invention describes terms such as comparing, validating, selecting, entering, or other terms that could be associated with the human operator. However, at least for a number of the operations described herein which form a part of the present invention, no action by a human operator is desirable. The operations described are, in large part, machine operations processing electrical signals to generate other electrical signals.

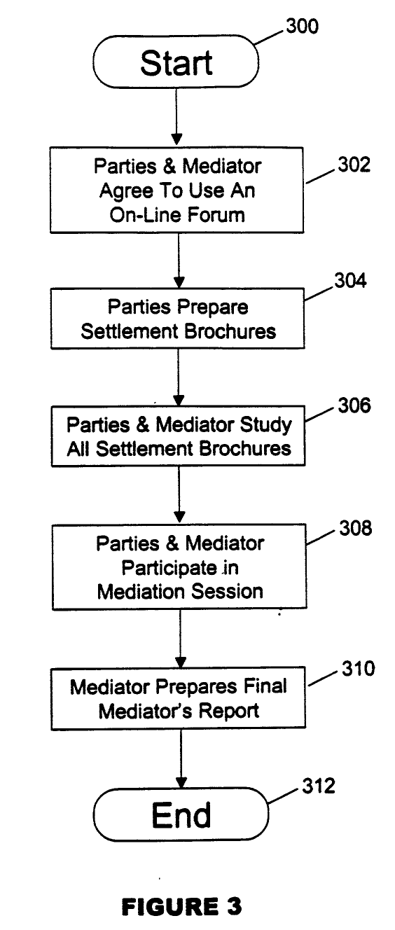

The foregoing has provided a general description of a communication environment that implements one embodiment of the present invention. Execution and operation of the present invention will subsequently be described in greater detail with respect to each of FIGS. 3 through 10. A description of operation of the data processing system and methodology of the present invention will now be provided in greater detail.

Refer now to FIG. 3, which illustrates a flow chart showing the methodology for an on-line mediation session using the present invention. This step occurs outside of the on-line environment. This type of mediation may be ordered by a court or agreed upon by the parties in order to more effectively negotiate a settlement to a dispute. The parties can either agree on one person or persons to serve as a mediator or mediators, the judge may recommend a mediator, or the parties may ask an ADR organization to find a suitable mediator. Once it is decided that a mediation is to occur (step 302), the parties will usually contact an independent third party to start the on-line process.

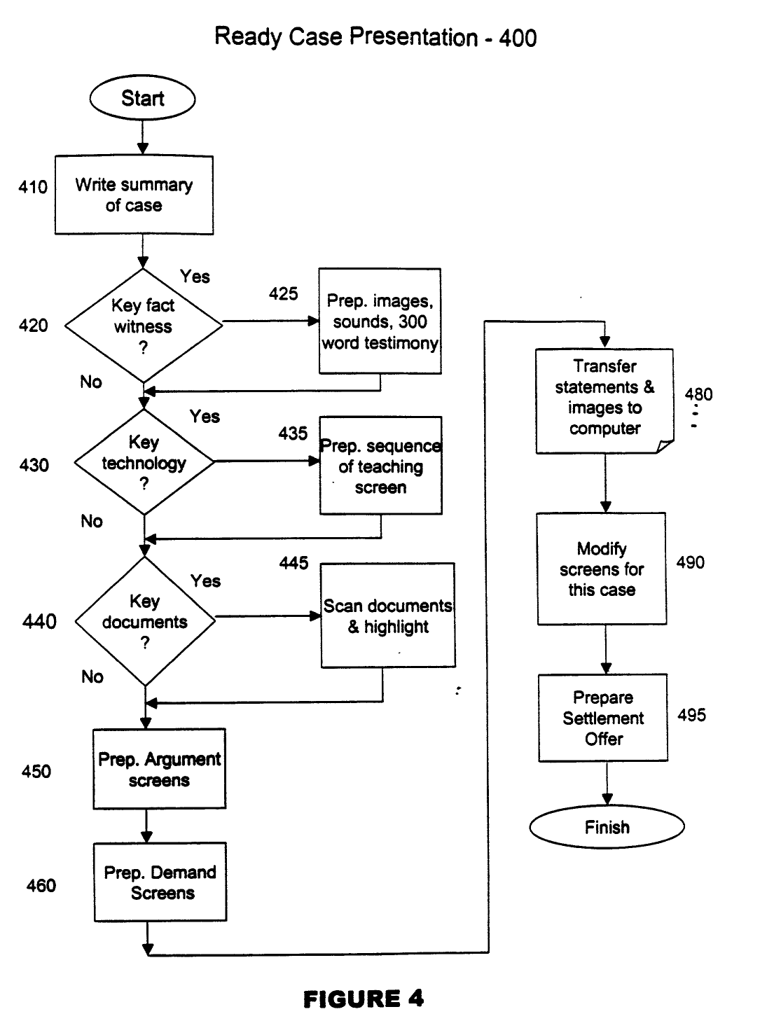

The next Step 304, after the parties have agreed to participate in the on-line mediation, is for the plaintiffs to prepare their case presentation. The case presentation is typically referred to as “settlement brochures” or “position papers.” This preparation step follows the basic logic illustrated in FIG. 4. Usually a deadline is set by the mediator for the submission of the settlement brochures. The settlement brochures are stored in the form of web pages on a web server 110 (FIG. 1). The URL's and necessary passwords to access them are kept confidential between the mediator and each party until the deadline when the mediator has determined that the settlement brochures shall be available for pre-mediation study.

Once the URL's and passwords are provided to all parties, the settlement brochures can be studied as indicated by Step 306. This step can be performed by several participants in each party separately and among themselves. The mediator also privately studies each party's settlement brochure before the mediation session begins. Step 308 signifies the beginning of the actual mediation process. The time duration for mediation may be limited to one day, several days of longer as determined by the mediator. If a judge has ordered a mediation, the mediator will usually prepare a final mediator's report for the judges review in Step 310. This step is optional and is not required if the parties voluntarily participated in the process. The process ends in Step 312 when the mediator will either determine that a settlement cannot be reached or a settlement between the parties will be reached.

As previously discussed, in Step 304 of FIG. 3, the parties prepare their settlement brochures. The trial lawyers work with a mediation facilitator to develop the screens, images, videos, and audio clips that will present the case information to the mediator. This presentation may be based on various settlement strategies and may utilize case summaries written by the lawyers. It may also include video-deposition testimony taken from key witnesses for video streaming, expert reports, documents retrieved during discovery, photographs of physical evidence and locations, computer reconstructions of events, graphic exhibits, audio-recorded statements by witnesses and lawyers, and videotape recordings of statements and lawyer arguments, and flexible implementation of video stream of real time events and arguments. FIG. 4 shows the methodology used in Step 304 (FIG. 3) to prepare the settlement brochure.

In FIG. 4, the party or the party's lawyer begins by writing a summary of case in Step 410. This summary is used to present the case to the mediator and to let the other parties know of the parties position. The summary includes a short statement about who the parties are and what the main complaints or disputes are. The summaries provide an introduction to the case to the case.

Sometimes key witnesses make important concessions or admissions during depositions. Video deposition excerpts in the form of streaming video-image of the witness may be used as part of the settlement brochure. Alternatives are streaming video segments coupled with a non-synchronized sound presentation of the witnesses' testimonies. Still photographs and written statements are other methods. In any scenario, the parties must decide what is most appropriate for that particular mediation session, and prepare the screen arrangement and file formats for the parties to view. This is done in Step 425.

An important part of preparing key fact witness testimony is to communicate the information from the witnesses, and their points of view, without producing too strong a bias for or against a party to the lawsuit. Whether key witness testimony will be used is determined in Step 420. If key witness statements are used, these are transferred to a computer readable medium in Step 425.

Just as there are key witnesses, some lawsuits involve key technological, scientific, or professional information. If a determination is made to present this information in Step 430, the key technology information must be prepared in Step 435. Examples of cases where key technology is important include toxic tort cases where the medical and scientific information is central to the case. Commercial cases often require technological knowledge of accounting or business methods. The party's lawyer will typically decide the most appropriate method to supply this information to the mediator.

If there is key technology in a case, then teaching screens may need to be prepared to teach the mediator about the science and technology typically learned from the expert witnesses. These screens include text definitions, graphical images, flowcharts, photographs, maps, etc.

If a party decides there are key documents in the case in Step 440, these documents or the applicable part of the documents should be scanned and the operative phrases highlighted for the mediator. This process is accomplished in Step 445. When indicated, the title of the document, and information about it is added in a caption.

Some of the screens in the case presentation present the arguments of the parties. These are prepared in Step 450. The demands of the party and damage summaries are prepared in Step 460. For example, the plaintiffs and defendants might both include tables for the mediator showing the damages they believe is appropriate. Depending on the mediator and the complexity of the case, some of these screens may need to be summarized in non-technical language.

The statements, images, videos, sound-bytes, charts, etc., that are prepared to present the case must be converted to computer data files in Step 480. These files may be into disk storage device 220 (FIG. 2) of server 110 (FIG. 1) that will support the on-line mediation. For example, if hypertext transmission protocol (“http”) and hypertext mark-up language (“html”) on the World Wide Web, or Web (“WWW”) is to support the on-line mediation process, then the various documents, descriptions, photographs, video- and audio-recordings, etc., would be transferred to the proper http file formats (e.g., .html, .jpeg, .txt, .ra). If another graphical user interface (“GUI”) is used to support the on-line mediation, then transfers would be made to the file formats appropriate for that GUI. The various information-containing files consist of the “exhibits” for the on-line mediation. The technical process of Step 480 is widely known by those skilled in the art.

In Step 490 the party reviews and modifies the basic information presenting screens of the computer program that supports the on-line mediation process. These screens have to have the correct links on them to present the files made in the previous steps. For example, if the on-line mediation system was implemented with the WWW technologies of http and html, then the documents and files would have to be listed on index pages and html links written to the actual files.

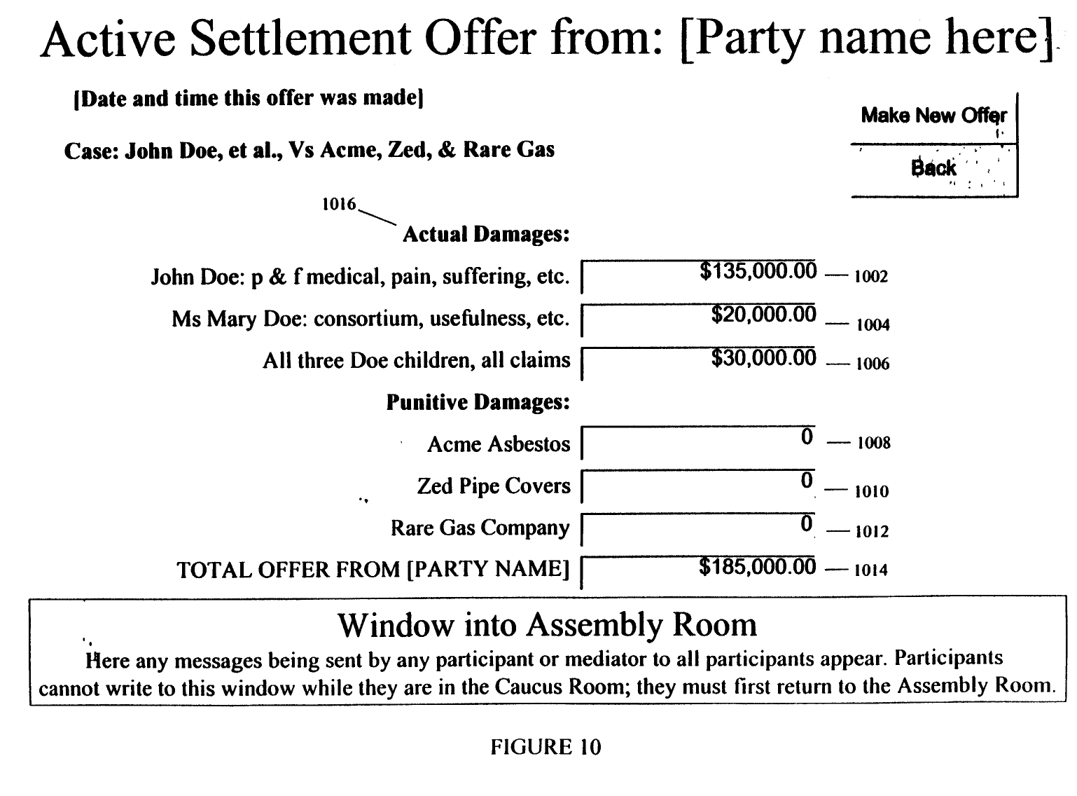

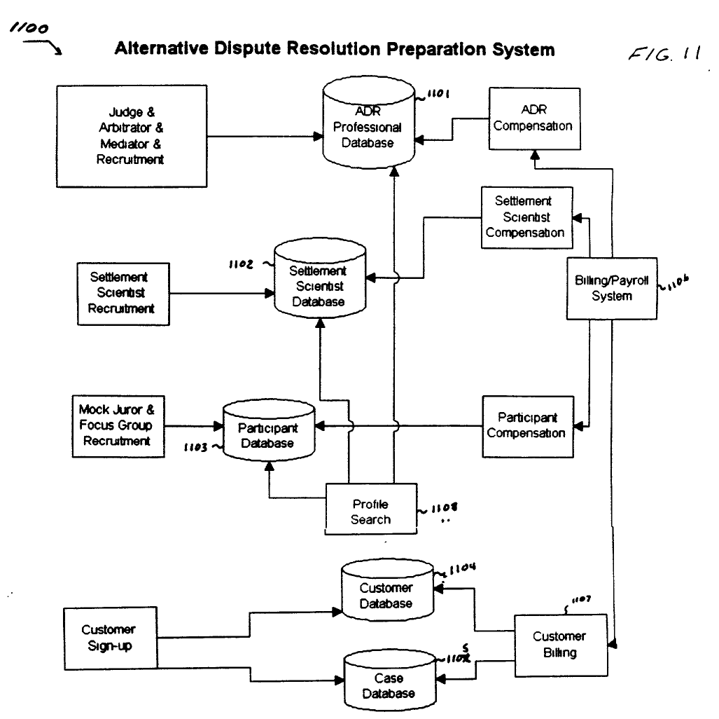

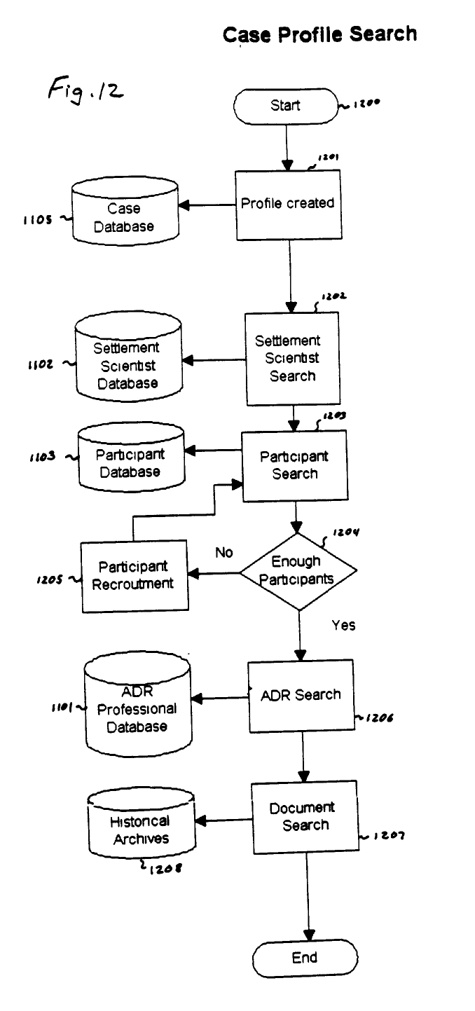

Part of preparing the settlement brochure is completing an initial “Latest Offer Screen” for each party (See FIG. 10). If a party has no current offer for settlement amounts when the actual mediation begins, then the dollar figures in their Latest Offer screen will be blank. Lines 1002 through 1014 (FIG. 10), and corresponding labels 1016 for lines 1002 through 1014 are determined by the mediator. When there are dollar figures in the separate lines for different damages, then total offer line 1014 will be computed by server 110 (FIG. 1). Optionally, a party can put a lump sum dollar amount in their latest offer screen (FIG. 10) by leaving blank separate damage lines 1002 through 1014 and just entering a number in total offer line 1014.

Once the parties and the mediator have studied the settlement brochures (step 306, FIG. 3), the mediation session can begin. The parties may study the opposing party's position by logging onto server 110. After the settlement brochure deadline, the parties are given a password that allows them to login into server 110 to view all of the settlement brochures. Step 306 involves the participants viewing the various exhibits, witnesses, case summaries, and any other portion of the on-line mediation that the lawyers have prepared. It is important to note that because of the methodology utilized in the present invention, it is not necessarily important that the participants study the case at the same time. In fact, because of the present invention, the participants can be notified of the date, time and location that they are required to enter assembly room 606 to begin the actual mediation session. In this manner, the participants need only gather at the same time in assembly room 606, after all participants have viewed the case. This flexibility allows the participants to complete Step 306 (FIG. 3) at their leisure prior to the mediation session. Also co-defendants or other parties may caucus on-line before the mediation session begins.

The parties are directed as to the time and computer interface they must use for the actual on-line mediation session as in Step 308 (FIG. 3). The password identifies the parties and ensures that only the proper parties are participating in the deliberations. Once the appropriate time and date arrives, different individuals representing the parties log into the on-line mediation process at Step 308 (FIG. 3).

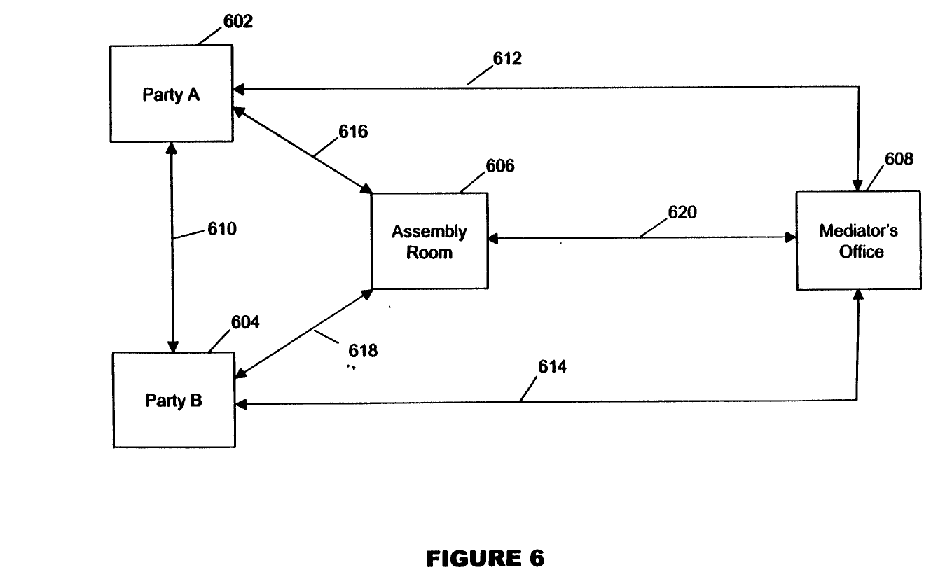

The present invention employs various chat rooms to facilitate communications between the parties. A chat room is an informal term for a data communication channel that links computers and permits user to “converse” by sending text messages to one another in real time. The key chat rooms and the corresponding data channels are illustrated in FIG. 6. Each party to a mediation is assigned to a separate chat room or caucus room. The passwords determine which chat rooms they can join. Individual representatives of the party may converse or “whisper” in private within their separate caucus rooms. Such caucus rooms are illustrated in FIG. 6 as caucus room 602 and caucus room 604. Assembly room 606 is provided as a chat room that all participates may view. Mediator's Office 608 is provided to allow the mediator to communicate both publicly and privately with the parties.

As FIG. 6 illustrates, the mediator can “whisper” to caucus room 602 through communication channel 612 allowing all individual participants logged to caucus room 602 to see this communication. Obviously, the number of data communication channels 612 and 614 will increase depending on the number of parties participating in the mediation session. The mediator can send messages to all parties via communication channel 620 which will appear as a message in Assembly “chat” Room 606. Similarly, participants logged to caucus room 602 can whisper to the mediator (seen by the mediator and all participants in the same party) through communication channel 612. They can whisper to any participant logged into their caucus room 602, or whisper to another party (such as a joint defendant) through communication channel 610. Finally, they can send messages in the Assembly Room screen through communication channel 616 to be seen by all participants.

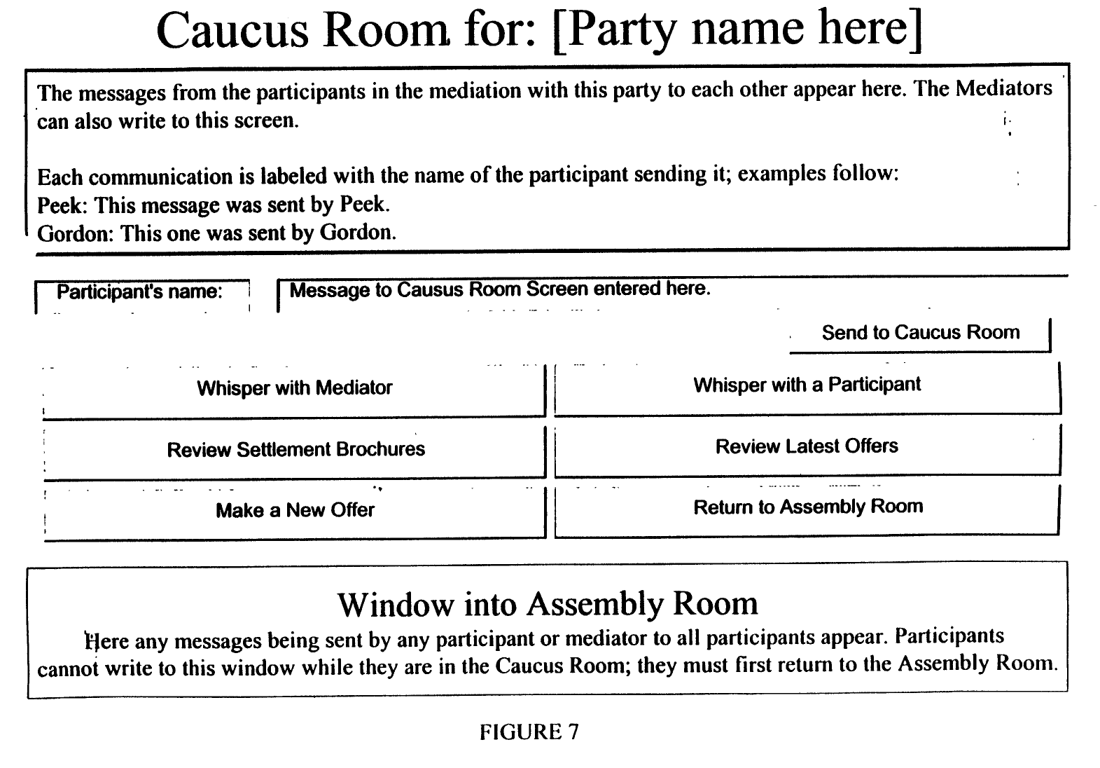

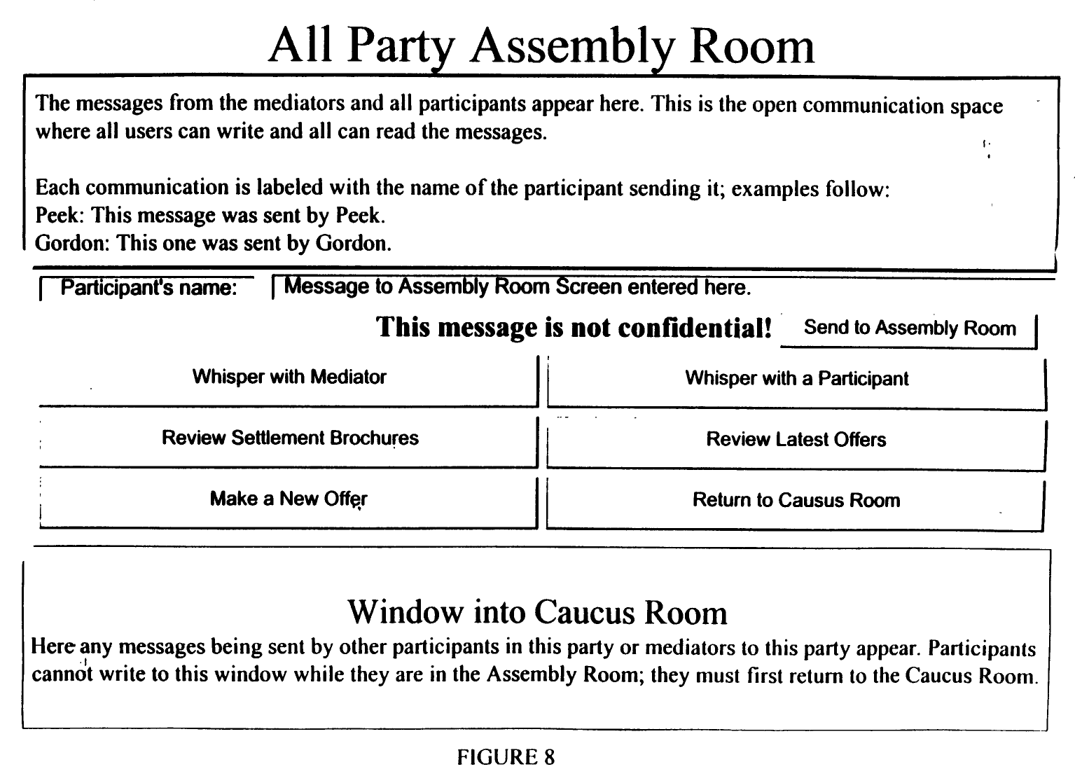

When a participant or mediator initiate whispers, they click on the whisper function in their respective caucus screen (FIG. 7) or the assembly room screen (FIG. 8). This process takes them to a special “pop-up” whisper screen. The whisper screen allows them to select the person they wish to communicate to by simply clicking the field identifier representing the person they wish to contact privately. It also allows them to type in the initial message. They then click the “send message” function.

The targets of the whisper communication are then supplied with a Whisper screen that “pops-up” when the whisper function is initiated with them. Here, they see who is communicating with them and the initial message. They may then type their reply if they so desire. Once their reply is composed, they click the “Send Message” or “No Reply” function, and return to the main rooms. This back-and-forth message sending continues until one person selects the “No Reply.” A person can be whispered to by more than one person at a time thus conducting multiple whisper sessions simultaneously. However, if no reply is made in a minute or two, then an automatic “No Reply” is generated. Automatic no replies happen when whispers are not heard by a person.

The present invention allows a participant or mediator to view any settlement brochure or latest offer while in any chat room. This will allow the participants to view materials while they are discussing them. The contents of the settlement brochure generally do not change during the active mediation; however, new information could be added and everyone be asked to review it by making an announcement to the Assembly Room screen. In contrast, the latest offer screen (FIG. 10) will change throughout the process. Only designated participants for each party can change these offers.

FIG. 7 is a representative sample of a caucus room as observed from a computer screen. It also illustrates the basic functions of the party's caucus room 602 or 604. Once logged into a caucus room, the participant will view a basic screen as illustrated in FIG. 7. This screen is designed to operate over http and html with javascript and java support. Other graphical interfaces in on-line courseware programs can support the on-line mediation system. This screen allows participants for each party to communicate amongst themselves. It also allows the participant to whisper with the mediator, review settlement brochures, make a new offer, whisper with a participant, review the latest offers or return assembly room 606.

FIG. 8 illustrates the basic functions on the available screens once the participant enters assembly room 606. This screen is also designed to operate over http and html with javascript and java support. Other graphical interfaces in on-line courseware programs can support the on-line mediation system. This screen allows the participant to post messages to all other parties and the mediator. It also allows the participant to whisper with the mediator, review settlement brochures, make a new offer, whisper with a participant, review the latest offers or return caucus room 602 and 604.

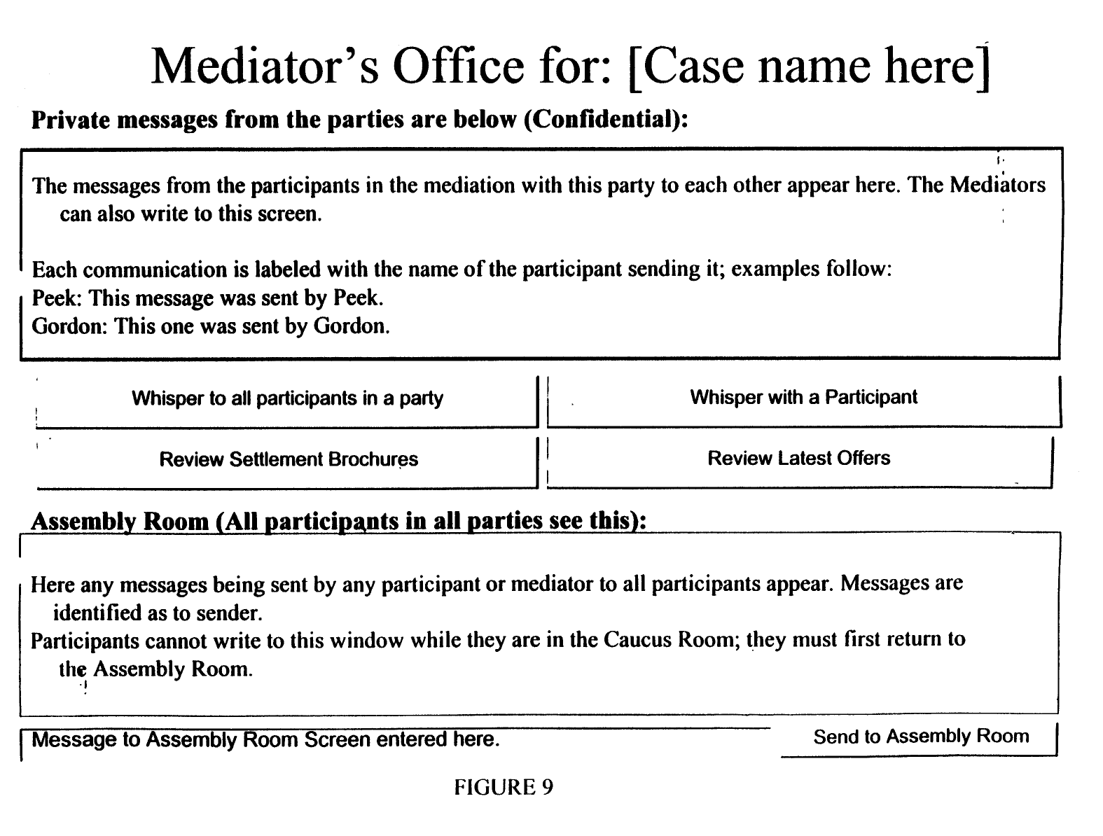

FIG. 9 illustrates the basic functions on the screen available once the mediator enters the mediator's office 608. This screen is also designed to operate over http and html with javascript and java support. Other graphical interfaces in on-line courseware programs can support the on-line mediation system. This screen allows the mediator to post private messages to selected parties or individual participants and to all other parties. It also allows the mediator to whisper with all participants in a party, review settlement brochures, whisper with a participant, or review the latest offers.

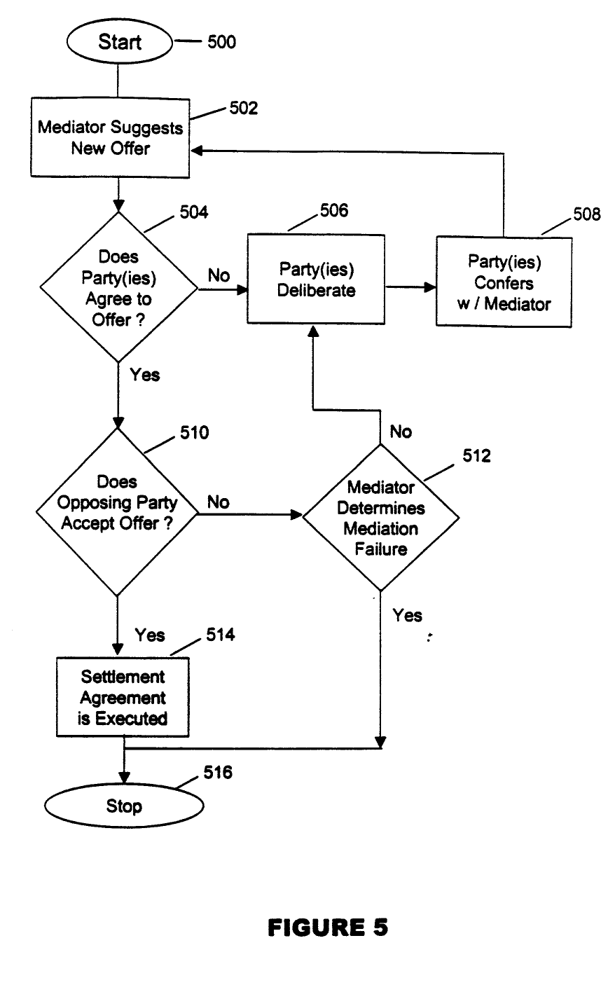

Turning now to FIG. 5 which illustrates the actual mediation process summarized in Step 308 of FIG. 3. The process begins at Step 500 once the parties have logged into assembly room 606. The mediator has reviewed the latest offers, and suggests a compromise offer in Step 502. The parties may or may not agree with the new offer and usually deliberate among themselves in Step 506 by going to caucus rooms 602 and 604. In Step 508, the party may privately whisper or discuss the offer with the mediator. Armed with confidential knowledge gained from the private communications, a mediator can selectively use the information derived from each side to: communicate positions or proposals in understandable or more palatable terms; reduce the hostility between the parties and help them to engage in a meaningful dialogue on the issues at hand; help each party to better understand the other parties' views and evaluations of a particular issue (without violating confidences); and determine the receptiveness for new settlement offers in Step 502.

If one party agrees to a new offer, the mediator tries to convince the other side to accept it. If the other side refuses the offer (step 510), the mediator determines if a settlement is possible in Step 512. Usually, however, the mediator forces the parties to deliberate again (step 506). Steps 502, 506 and 508 are usually repeated numerous times. During each private communication with a party in Step 508, the mediator clarifies each party's interpretation of the facts, and their positions. The mediator tests and challenges the validity of each party's positions, both from a legal and factual perspective. Through the private and candid discussion of the issues of each party, the mediator attempts to make each party think through demands, priorities, and views of the other party. The mediator also reminds the parties of the expense of litigation, possible proof problems, and problems with the party's legal position. Furthermore, the mediator presents the other party's arguments to the party, so each party must answer the party's arguments in some fashion. At appropriate times, the mediator makes suggestions about a final settlement, stresses the consequences of failure to reach agreement, emphasizes the progress which has been made, and formalizes offers (step 502) to gain an agreement.

Sometimes, as Step 512 indicates, the mediator determines that a settlement is not possible. When this occurs, the mediator declares the mediation to be finished (step 516), the process then returns to Step 310 of FIG. 3. At other times, the parties will reach an agreement. In Step 514, when the parties reach an agreement, they reduce the terms to writing in the form of a binding settlement agreement. The mediation is then over and the process returns to Step 310 of FIG. 3.

It is important to note that in this embodiment, it is not required for the mediation to occur in at any physical location. In fact, the parties and the mediator are simply linked into a facility, with each party located at a separate and distinct location. The important distinction and utilization of this invention is that the participants are not required to be in a central location, and therefore time, cost and expense are saved. As described above, the participants have access to the trial exhibits, the witness depositions, the cross-examinations and directs, and the various trial exhibits that were admitted into evidence as appropriate. Therefore, if a participant wishes to review an exhibit or cross-examination, for example, the juror is able to “call up” the appropriate exhibit to view during the negotiations and deliberations.

According to the principles of the present invention, methods and systems are provided for preparing participants to engage in virtual (online) ADR, including not only mediation, such as that described above, but also virtual bench and jury trials, as well as virtual arbitration. These processes will each be discussed in further detail below. Generally, through simulated (mock) ADR procedures performed online, and subsequent analysis, the client is given valuable information from which decisions regarding risk management, risk exposure and risk/opportunity, can be made with enhanced confidence. Moreover, the information developed provides an indicator of the effectiveness of the ADR proceeding in terms of monetary value.

FIG. 11 is a block diagram illustrating a preferred database system 1100 used for providing virtual ADR preparation services. It should be recognized however that the procedures discussed below are not necessarily limited to preparing parties for ADR through mock ADR procedures and analysis. In particular, these procedures can also be used to conduct actual ADR procedures, as well as performing post-ADR analysis. An ADR Professional Database 1101 maintains a list of recruited judges, arbitrators and mediators willing to participate in the selected ADR preparation procedure, along with a record of their professional fees charged for such participation.

Similarly, a Settlement Scientist Database 1102 is maintained which retains the names of available settlement scientists willing to analyze the ADR preparation procedure and render advice to the contracting party (customer). The professional fees charged by the respective settlement scientists are also stored in database 1102.

A third database, the participant data base 1103, includes information on a set of recruited mock jurors and focus group members, along with information indicating their proposed compensation. A customer data base 1104 maintains records pertinent to each customer who wish, or who may wish to avail themselves of the virtual ADR preparation system. Records on each case, including information generated during the simulation processes discussed below are maintained in a case database 1105.

Computerized billing/payroll system 1106 is able selectively to extract compensation information from the ADR professional, settlement scientist and/or participant databases as a function of the participants selected for the given preparation procedure. The extracted information is then passed to the computerized customer billing system 1107 such that the customer can be appropriately billed for the professional services rendered. A selection of ADR professionals, settlement scientists, and participants is preferably done through a computerized profile search system 1108. A preferred profile search procedure 1200 is shown in FIG. 12.

In accordance with procedure 1200, a profile is created at Step 1201 during the initial case setup by the first settlement scientist analyzing the case. Depending on the type of ADR involved, profiles are created for the appropriate ADR professional, focus group participants, and/or jurors. For example, in the case of a mock ADR procedure the requisite professionals (arbitrators, mediators or judges) may be recruited and selected based on the professional characteristics, demographics, and/or view of the actual professionals expected during the actual ADR procedure. Profiles are also set up to simulate opposing parties. Once created, the profiles are stored in case database 1105.

Based on the case profile created at Step 1201, additional settlement scientists may be recommended at Step 1202 using settlement scientist test data base 1102. If a new settlement scientist is chosen, the profile for settlement scientist set up in case database 1105 may be changed based on the experience of the chosen new settlement scientist.

Depending on the given type of ADR procedure, participants (e.g. focus group members, mock jurors) that match the requisite profile are selected out of participant data base 1103. If, at Step 1204, it is determined that there are not enough qualified participants available in the current participant data base, then, at Step 1205, participant recruitment is undertaken as required to support the simulation.

At Step 1207, any documents within the system historical archives 1208 are searched based on profile. Any document with a profile which is similar to those similar to a previous case, are marked for review.

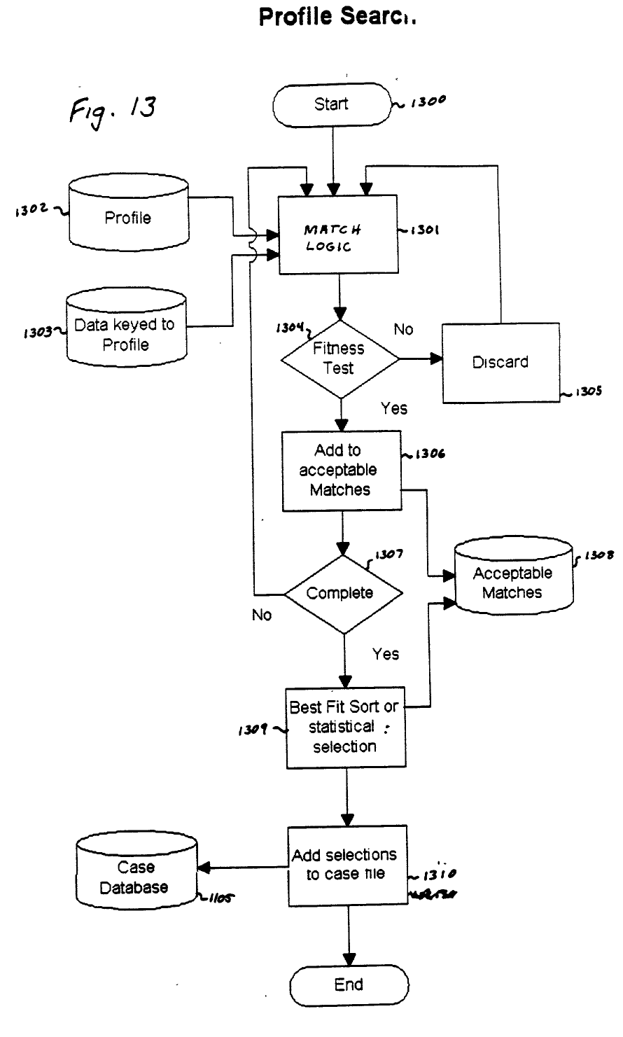

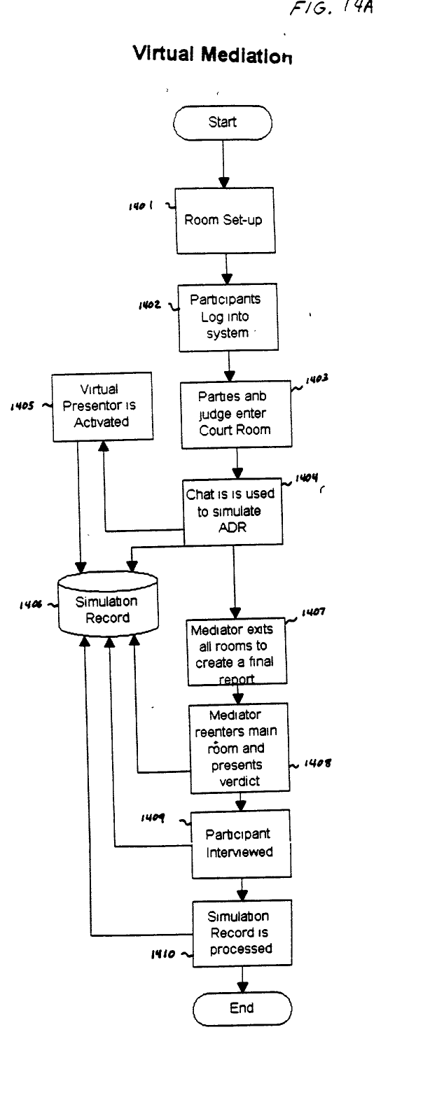

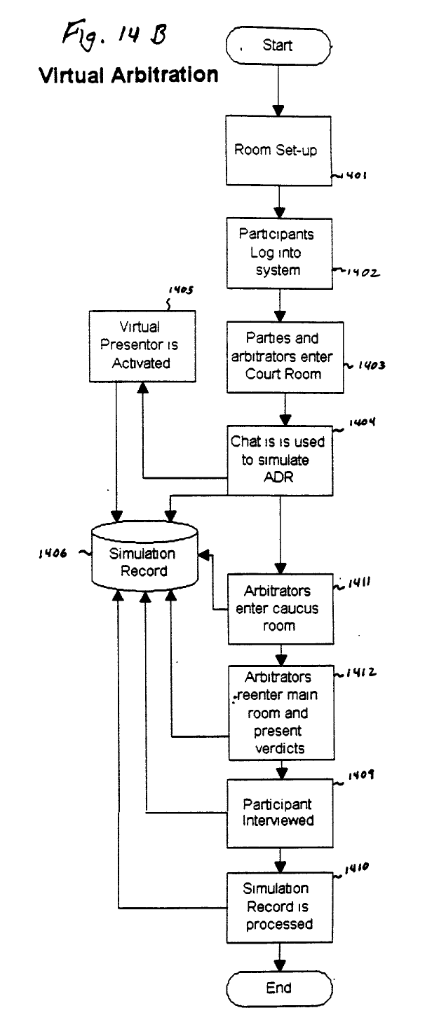

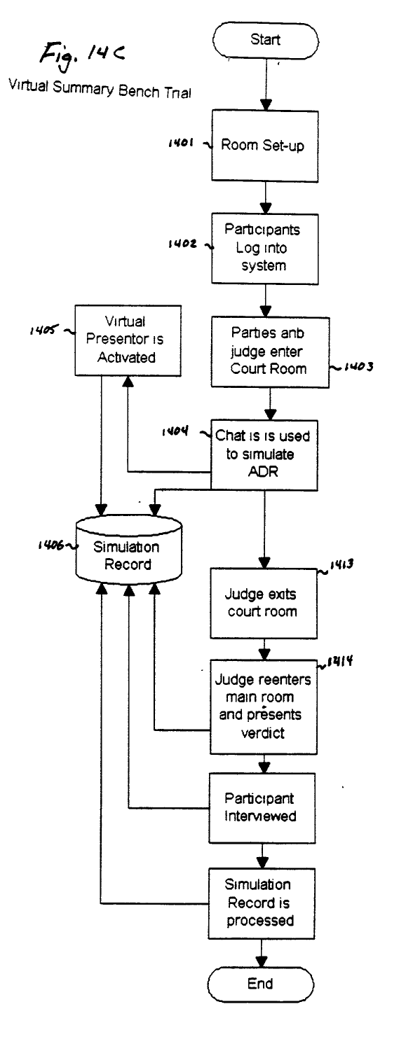

FIG. 13 is a more detailed flow chart of a procedure 1300 for implementing the case profile search of FIG. 12. At Step 1301, match logic is used to determine the best possible matches between the profile data stored in memory at Step 1302, and data keyed to the profile at Step 1303. The match logic compares information, for example, using fuzzy logic, Boolean logic, string comparisons, and other matching algorithms and methods known in the art. In the case of selecting ADR professionals for a simulation, matches with the actual ADR professionals expected is the general criteria, as was mentioned above. In the case of jurors, the traditional legal means of disqualifying individuals, including strikes for cause, peremptory strikes, exemptions, excuses, and eligibility criteria, are applied. If the fitness test applied by the fuzzy logic does not show a match at Step 1304, then the examined profile is discarded at Step 1305, otherwise if a match does occur, then at Step 1306, that profile is added to the set of the acceptable matches, and corresponding record stored in memory at Step 1308. This procedure continues to loop at Step 1307 until all the profiles in the search have been examined.

When the search has been completed, a sort on fitness or statistical sampling is implemented at Step 1309, to determines a selected number of best matches at Step 1309 and added to the case database as Step 1310.

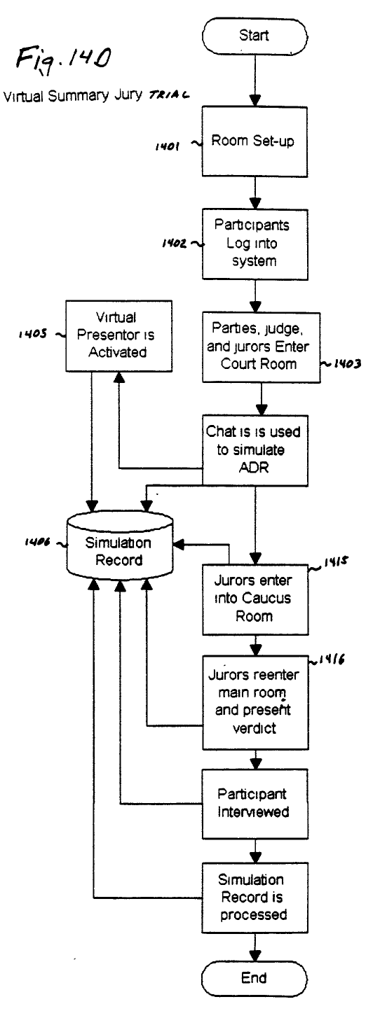

Once the requisite ADR professional, settlement scientist, focus group and/or mock jury participants and a putative opposing party have been selected, the simulated virtual ADR procedure can proceed. For purposes of discussion, the procedures for a simulated virtual mediation, simulated virtual arbitration, virtual summary bench trial and simulated virtual summary jury trial, according to the principles of the present invention, are illustrated in FIGS. 14A-14D, respectively. It should be noted that identical or substantially similar steps have been given the same designator numerals.

In each case, the requisite chat rooms are set up for the various parties at Step 1401. In the case of an arbitration (actual or simulated) a hearing room is set up for the exchange of information between the parties and between the parties and the arbitrators. Additionally, caucus rooms are set up for each of the parties, as well as for the arbitrators. Similarly, for a mediation, a hearing room and caucus rooms are set up. To conduct a summary jury trial, a courtroom is set up along with a Judge's Chambers, a Jury Room for deliberations, as well as caucus rooms for the parties and their counsel, as required. In each case Adam The Virtual Presentor™ provides documents, video, graphs, charts and witness testimony (textual or video) to each of the rooms. (The presenter is also known under the mark SETTLEVISION™).

At Step 1404, the rooms set up at Step 1401 are used to simulate the given ADR procedure. In the case of a virtual mediation, the main mediation room experience is simulated, whereas for the summary trial procedures a court room atmosphere is simulated and for a virtual arbitration, an arbitration room is simulated. Lawyers and their clients, can communicate with each other using the caucus and private party rooms. Moreover, a virtual presenter is activated at Step 1405 to aid in the presentation of evidence. The virtual presenter allows the party to put on demonstrative evidence, such as charts and pictures, document excerpts, or live testimonial clips such as those taken at videotaped depositions. Each room preferably has access to the virtual presenter.

Activities in all rooms may be recorded for future review and analysis. Additionally, for each ADR case, a simulated record is generated and stored at Step 1406, also for later review and analysis by the settlement scientists and/or customer.

In the case of the virtual mediation procedure shown in FIG. 14A, the mediator exits all rooms at Step 1407 to create a final report in private. This report may include, for example, information concerning any of the mutual agreements that were reached by the parties as well as any disagreements that have not been settled or remain to be mediated. Subsequently, the mediator re-enters the main mediation room at Step 1408 and renders the final report. This final report is made a part of the simulation record 1406. Additionally, all participants in the mediation are interviewed by the settlement scientist who takes the resulting information and processes it, along with the record of the simulation, to prepare a report and analysis of the procedure.

The virtual arbitration, and virtual summary trial procedures are similar. In the case of the virtual arbitration, the arbitrators enter a private caucus room at Step 1411 at the end of the arbitration presentation to deliberate, come to a verdict, and fashion remedies, if any. The arbitrators re-enter the main arbitration room at Step 1412 and present their verdict and remedies, this presentation also being stored in the simulation record. The procedure continues as before, with the settlement scientist interviewing the participants involved in the foregoing procedure, analyzes the simulation records, and provides his analysis and conclusions to the customer.

In the case of the simulated virtual summary bench trial shown in FIG. 14C, the judge exits the court room at the end of the presentations by the parties to deliberate at Step 1413. Once the judge has completed deliberations, the judge re-enters the main courtroom at Step 1414 and presents the verdict, which is made part of the simulation record. For a simulated virtual summary jury trial, the jurors enter their caucus room at Step 1415 at the end of the presentation by the parties to deliberate and re-enter the main courtroom at Step 1416 to present their verdict, once that verdict has been reached. In both cases, the steps of interviewing all the participants interviewing the simulation record by the settlement scientist are preferably performed (Steps 1409, 1410).

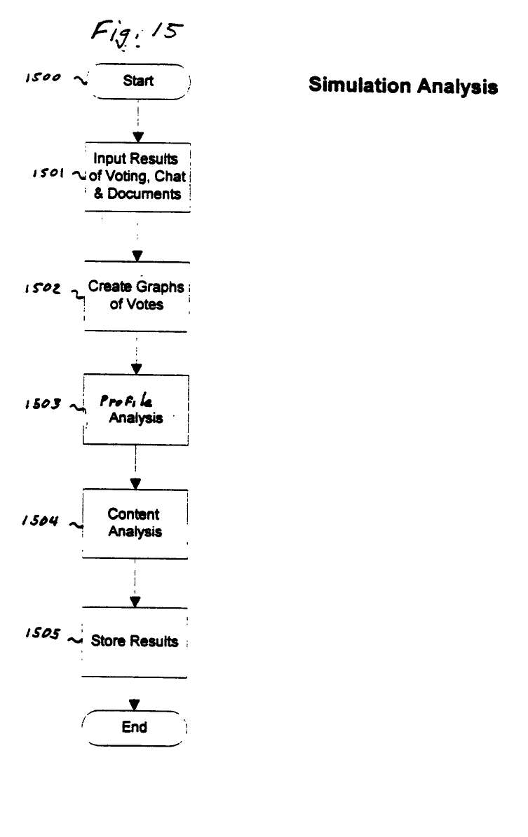

FIG. 15 is a flow chart of a preferred procedure 1500 for analyzing the session record generated during the procedure discussed above in connection with FIGS. 14A-D.

At Step 1501, data from the virtual sessions, including documents, and other textual information, as well as vote-based data in the case of jury trials and arbitration, are input into the system for analysis. For those ADR procedures requiring votes from either jurors or arbiters, the voting results are graphed against their subjects and various other data (Step 1502).

Next, at Step 1503, a profile analysis in which the voting results are related to the demographics, psyche graphics, and other contextual information describing the voting individuals. With respects to demographics, votes are analyzed with respects to such factors as race, gender, age, education, occupation, occupation of significant others, marital status, parental status, ethnic background, political party affiliation, socio-economic status and religion. Psychographic analysis analyzes personality variable such as thinking, feeling and behavior style. For example, psychographic analysis considers such factors as whether the given individual considers the world just or unjust, whether that individual displays bumper stickers, and life experiences, such as whether that individual works in a hospital, nuclear power plant, or similar environment. Additionally, the intensity of attitude (i.e., how strongly does each juror feel with respect to their decision) may also be considered with the results averaged and/or graphed.

At Step 1504, content analysis is performed on the transcript and other textual information. For example, Osgoode semantic differential analysis of words and phrases may be performed. In addition, words and phrases relevant to the case at hand may be counted and/or graphed. For example, the number of occurrences of the use of the terms “injury,” “death”, “putative damages”, etc.

The results of the application of the various analytical tools are stored in memory at Step 1505 for later retrieval and use in preparation of reports and/or human analysis.

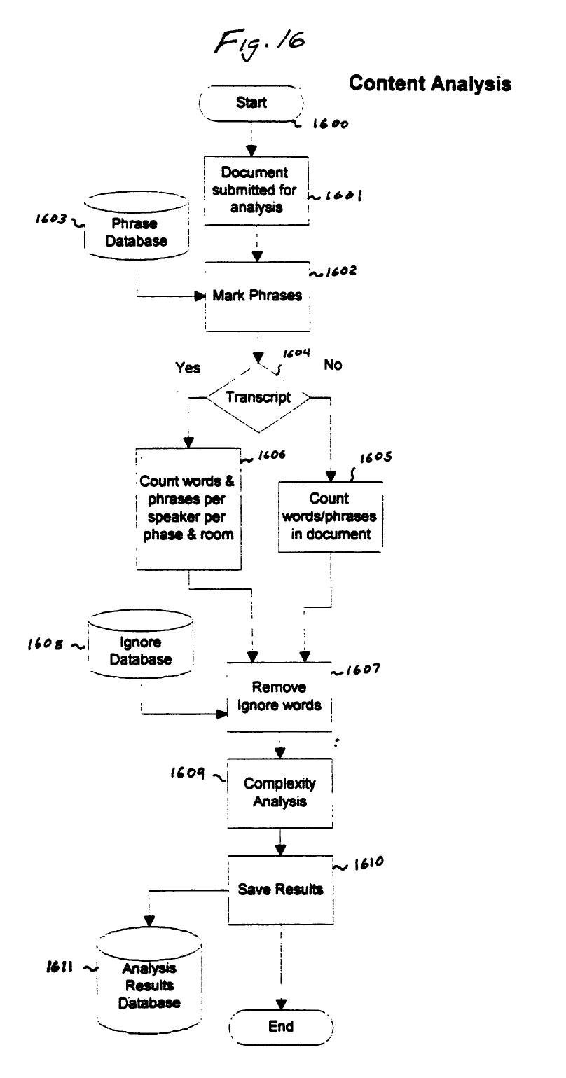

FIG. 16 is a flow chart of one particular method of performing content analysis on the information developed during either a mock or actual ADR procedure. Method 1600 begins at Step 1601 where the document to be analyzed is submitted and appropriately entered into the analysis system. At Step 1602, phrases which are relevant to the analysis of the given case, are marked as countable entries using a phrase database 1603.

A determination is made at Step 1604 as to whether the document being analyzed is the proceeding transcript or a document submitted during any step of the ADR proceedings. In the case of documents in general, the marked words and phrases in the documents are counted and the counts aggregated by paragraph. In the case of the proceeding transcript, words and phrases are counted per speaker per the phase of the proceeding and the room from which the portion of the transcript was taken. Next, at Step 1607, “ignore words” are removed using an ignore word database 1608. The “ignore words” are words like “the”, “are” and other non-context words which are removed from the results.

A complexity analysis of the paragraphs and sentences is performed at Step 1609 to estimate their readability and understandability. All of the final results are then saved at Step 1610 into an Analysis Results Database 1611. It should be noted that intermediate save and/or retrieve operations may occur at any point during the processing, as required. The results in Analysis Results Database 1611 are available for creating reports, human analysis, and integration with other analysis data and tools.

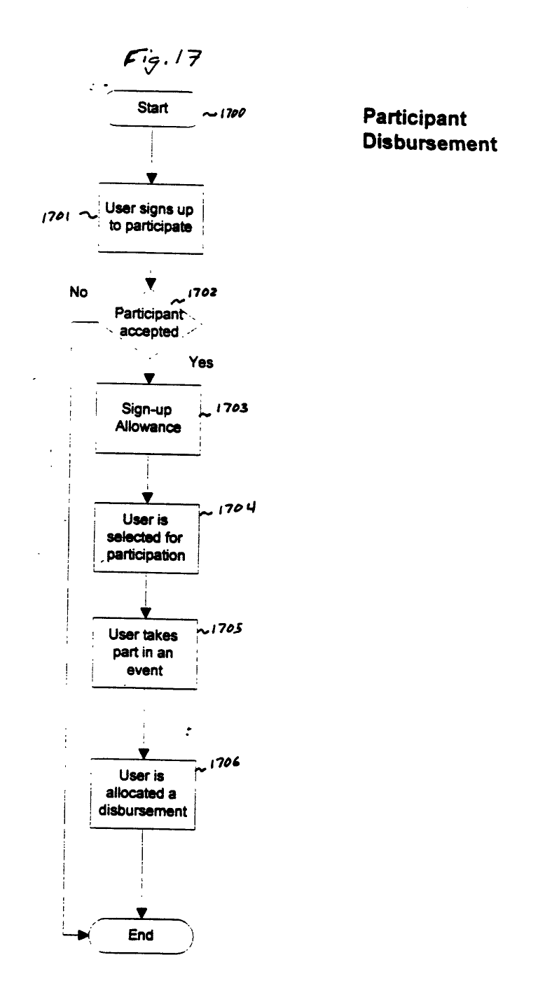

It should also be noted that participants required for mock juries, focus groups, or other events may receive compensation for their efforts. This compensation may take the form of a cash disbursement, coupons or gift certificates to various retailers, or airline frequent flyer miles, among other things. FIG. 17 depicts one procedure for providing disbursements to the various participants.

At Step 1701, a prospective participant signs up to participate in the mock jury trial, focus group or other event. Then, at Step 1702 tests are performed to ensure that the user is qualified and that the participant has not submitted any fraudulent information with regards to their demographics, psychographics or other pertinent personal information. If the participant is not qualified for any reason, procedure 1700 simply ends. Otherwise, at Step 1703 the participant is given a sign-up allowance as an incentive to sign up to participate in future proceedings or events.

Participants (user) are selected at Step 1704 to participate in the proceeding or event. This selection is done either by a settlement scientist or by an automated selection system. Once selected, the participant takes part in the proceeding or event at Step 1705 and then is allocated the appropriate disbursement for their successful participation at Step 1706.

In sum, the principles of the present invention allow for the establishment of a thoughtful ADR strategy. This includes the development of themes, arguments, positions and visual evidence through testing in an accurately simulated ADR environment. Moreover, these principles allow for the creation of thorough transcripts and reports for use by the settlement scientists and client.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention.

It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed:

1. A method of performing a selected alternate dispute resolution procedure online comprising the steps of:
selecting at least one alternate dispute resolution professional;
setting up a main chat room accessible by the alternate dispute resolution professional and first and second disputing parties;
setting up a private chat room accessible by a selected one of the disputing parties and counsel for the selected disputing party for conducting private information exchanges;
activating a virtual presenter accessible in the main chat room for presenting evidence; and
conducting the alternate dispute resolution procedure through the exchange of information through chat in the main chat room and the presentation of evidence using the virtual presenter.

2. The method of claim 1 wherein said steps of setting-up main and private chat rooms comprise the steps of setting up chat rooms accessible by a global computer network selected from the group comprising the Internet and World Wide Web.

3. The method of claim 1 wherein the selected alternate dispute resolution procedure is selected from the group comprising arbitration, mediation, summary jury trial and focus group trial.

4. The method of claim 1 wherein the selected alternate dispute resolution procedure comprises a method of performing a selected alternate dispute resolution procedure online in preparation for a subsequent alternate dispute resolution procedure.

5. The method of claim 1 wherein said step of selecting at least one alternate dispute professional comprises the step of searching profiles in an electronic database.

6. The method of claim 1 wherein the virtual presenter is operable to present evidence in a form selected from the group comprising video-deposition testimony, documents, photographs, graphics exhibits, audio statements and computer reconstructions.

7. The method of claim 1 wherein the virtual presenter is operable to present arguments of lawyers.

8. The method of claim 1 and further comprising the step of performing a post-procedure analysis.

9. The method of claim 8 wherein said step of performing a post-procedure analysis comprises the substeps of:
creating a session record concurrent with said step of conducting the alternate dispute resolution procedure; and
performing content analysis on the session record.

10. The method of claim 1 and further comprising the step of selecting a focus group for analyzing the alternate dispute resolution procedure.

11. A computer network for implementing alternate dispute resolution procedures comprising:
a plurality of interconnected terminals operable to:
maintain a first chat room for exchanging information between an alternate dispute resolution professional and a plurality of disputing parties;
maintain a second chat room for exchanging confidential information between said professional and a first one of said parties; and
maintain a third room for exchanging confidential information between said professional and a second one of said parties.

12. The computer network of claim 11 wherein said network is further operable to maintain a virtual caucus room for exchanging information between a selected disputing party and counsel representing said selected party.

13. The computer network of claim 11 wherein said network implements a presenter operable to present audio and visual presentations to selected ones of the parties and the professional through corresponding ones of said terminals.

14. The computer network of claim 11 wherein at least one of said terminals communicates with said server via a global computer network selected from the group comprising the Internet and World Wide Web.

15. The computer network of claim 11 wherein said first chat room simulates an assembly room.

16. The computer network of claim 11 wherein the professional communicates with said parties through said second and third chat rooms via pop-up screens.

17. The computer network of claim 11 and further comprising a database for selecting said alternate dispute resolution professional.

18. The computer network of claim 11 and further comprising a database for selecting a settlement scientist for analyzing a said alternate dispute resolution procedure conducted using said computer network.

19. The computer network of claim 11 wherein said first chat room simulates a courtroom.

20. The computer network of claim 19 and further comprising a chat room for jury deliberations.
